(19) United States
(12) Patent Application Publication
(10) Pub. No.: US 2023/0237052 A1
(43) Pub. Date: Jul. 27, 2023

(54) REAL-TIME DATA MANIPULATION SYSTEM VIA BW CUBE

(71) Applicant: SAP SE, Walldorf (DE)

(72) Inventors: Deepti Devraj, Bangalore (IN); Virendra Shukla, Bengaluru (IN); Piyusha Anand Buldeo, Bangalore (IN)

(21) Appl. No.: 17/583,793

(22) Filed: Jan. 25, 2022

(51) Int. Cl. G06F 16/242; G06F 16/28; G06F 16/2453; G06F 16/2455; G06F 16/25

(52) U.S. Cl. CPC G06F 16/2423; G06F 16/283; G06F 16/24549; G06F 16/24556; G06F 16/256

(57) ABSTRACT

Systems and methods are provided for a computing system in a cloud computing environment to receive a request for planning data via a user interface of a computing device accessing a planning application executing in the cloud computing environment and to execute queries corresponding to the request for planning data against an SAP Business Warehouse Integrated Planning Cube (BW cube). The computing system loads data received from the executed queries into an application layer of the planning application executing in the cloud computing environment and stores each manipulation action to the loaded data in the application layer of the planning application executing in the cloud computing environment without persisting any data to the BW cube. The computing system persists the updated data to the BW cube only upon detecting completion of the manipulation actions.

### BACKGROUND

An SAP Business Warehouse Integrated Planning Cube, referred to herein as a “BW cube,” is an object on which queries can be defined or executed. A BW cube can physically store data in real database tables or virtually collect the data without storing it permanently. A BW cube consists of a set of relational tables that are joined logically to form an extended star schema such that multiple dimension tables are joined through a fact table.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 comprises a flow chart illustrating aspects of a method, according to some example embodiments.

FIG. 3 illustrates an example user interface, according to some example embodiments.

FIG. 4 is a block diagram illustrating an example of a software architecture that may be installed on a machine, according to some example embodiments.

FIG. 5 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to a real-time data manipulation System via BW cube. As explained above, a BW cube is an object on which queries can be defined or executed. A BW cube can physically store data in real database tables or virtually collect the data without storing it permanently. A BW cube consists of a set of relational tables that are joined logically to form an extended star schema such that multiple dimension tables are joined through a fact table. Conventionally, to access or interface with a BW cube, a separate application is needed to utilize runtime buffers, which creates significant inefficiencies because of the number of times the BW cube must be accessed and only allows manipulation of one data set at a time, which is not practical when planning activities that typically comprise multiple data sets.

For example, planning, such as financial planning, resource planning, forecasting and the like, is a core activity for any business. Planning for a project structure spans across multiple periods, with a varied combination of characteristics and key figures in each business scenario. Simple, quick, and functionally correct solutions are key in any planning activity. The plan can be stored in a BW cube for planning and analysis; however, a separate application is needed to perform any operations on the data set so that runtime buffers can be used. These runtime buffers have limited use because when data from a first data set (e.g., a first table) is present in the runtime buffer, when another query on a second data set (e.g., a second table) is run, the data from the second data set will have to be loaded into the buffer, resulting in the data of the first data set getting displaced from the buffer. Thus, when a user manipulates data from a first data set and then wants to manipulate data from a second data set, the user must first save the manipulated data from the first data set before the user can manipulate data from the second data set. This requires a large number of remote function calls made to the underlying BW cube layers which results in significant lag time for each access and an unnatural process for manipulating data.

For example, if a user is planning a large construction project and wishes to update a cost of materials, a labor requirement, and a timeline for an aspect of the project, the user must go through numerous steps and wait up to a minute for each step, just to manipulate these values. For instance, the cost of materials may be in a first data set, and once the user has updated the cost of materials, the user must save the updates to the BW cube before updating the labor requirement, which is in a second data set. If the user does not do so, the first update to the cost of materials will be overwritten when the user updates the labor requirement.

Moreover, installation and maintenance for such applications is a large overhead and difficult to manage when there are different applications used by different users and the backend system with the BW cube may not have control over those applications. For example, if an update is needed to a first application, it is a cumbersome process to get that application updated, generally, let alone on each computing device of each user. Further, if any updates to the applications cause issues to the interface with the BW cube, it takes time to figure out the issue and then get each application updated.

To address these and other technical issues and inefficiencies, the disclosed embodiments provide for a real-time manipulation and rendering of data via a BW cube by removing reliance on additional applications installed on various computing devices and instead utilizing an application layer of a cloud-based application executing in a cloud computing environment. In this way, remote function calls made to underlying BW cube layers are reduced to almost zero while achieving planning end results faster with a single call. Thus, the disclosed embodiments provide for a faster and more efficient system as well as a more natural and efficient user experience. For example, when further processing is needed when manipulating data for planning, such as recalculating planning data, persisting an intermediate result set to the BW cube is not required prior to performing another calculation. Moreover, this provides for a user interface (UI) agnostic solution and can be consumed by other applications, with the above-mentioned performance and usability benefits.

For instance, embodiments described herein provide for a computing system in a cloud computing environment to receive a request for planning data via a user interface of a computing device accessing a planning application executing in the cloud computing environment and executing queries corresponding to the request for planning data against an SAP Business Warehouse Integrated Planning Cube (BW cube), the BW cube consisting of a set of relational tables that are joined logically to form an extended star schema. The computing system further loads data received from the executed queries into an application layer of the planning application executing in the cloud computing environment and causes the loaded data to be rendered in the user interface of the computing device accessing the planning application executing in the cloud environment. The computing system receives, via the user interface of the computing device accessing the planning application executing in the cloud environment, a plurality of manipulation actions to the loaded data received from the executed queries and causes data to be updated and rendered in real-time, based on each manipulation action of the plurality of manipulation actions, in the user interface on the computing device accessing the planning application executing in the cloud computing environment. The computing system further stores each manipulation action of the plurality of manipulation actions in the application layer of the planning application executing in the cloud computing environment without persisting any data to the BW cube. The computing system detects completion of manipulation actions in the planning application via the user interface of the computing device accessing the planning application executing in the cloud environment and, based on detecting the completion of manipulation actions in the planning application, persists updated data based on the plurality of manipulation actions to the BW cube. The updated data is not persisted to the BW cube until the completion of manipulation actions is detected.

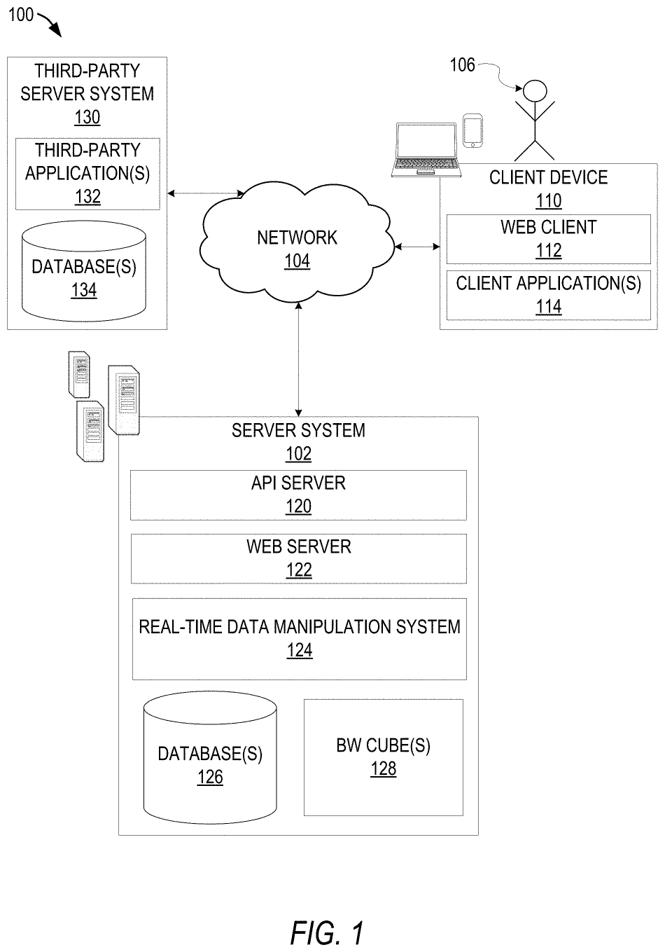

FIG. 1 is a block diagram illustrating a networked system 100, according to some example embodiments. The system 100 may include one or more client devices such as client device 110. The client device 110 may comprise, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other computing or communication device that a user may utilize to access the networked system 100. In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, global positioning system (GPS) devices, and so forth. The client device 110 may be a device of a user 106 that is used to access and utilize cloud services, a real-time data manipulation system 124, one or more BW cube(s) 128, among other applications.

One or more users 106 may be a person, a machine, or other means of interacting with the client device 110. In example embodiments, the user 106 may not be part of the system 100 but may interact with the system 100 via the client device 110 or other means. For instance, the user 106 may provide input (e.g., touch screen input or alphanumeric input) to the client device 110 and the input may be communicated to other entities in the system 100 (e.g., third-party server system 130, server system 102) via the network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 may further include a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, a search engine, a messaging application, an electronic mail (email) application, an e-commerce site application, a mapping or location application, an enterprise resource planning (ERP) application, a customer relationship management (CRM) application, a user interface for a real-time data manipulation system 124 or BW cube(s) 128, and the like.

In some embodiments, one or more client applications 114 may be included in a given client device 110, and configured to locally provide the user interface and at least some of the functionalities, with the client application(s) 114 configured to communicate with other entities in the system 100 (e.g., third-party server system 130, server system 102, etc.), on an as-needed basis, for data and/or processing capabilities not locally available (e.g., access location information, access software version information, access an ERP system, access a CRM system, access machine learning models, access procurement, spend management and supply chain services, to authenticate a user 106, to verify a method of payment, access test data, access a development landscape build system and so forth), to access a real-time data manipulation system 124 or data cube(s) 128, and so forth. Conversely, one or more applications 114 may not be included in the client device 110, and then the client device 110 may use its web browser to access the one or more applications hosted on other entities in the system 100 (e.g., third-party server system 130, server system 102).

A server system 102 may provide server-side functionality via the network 104 (e.g., the Internet or wide area network (WAN)) to one or more third-party server system 130 and/or one or more client devices 110. The server system 102 may include an application program interface (API) server 120, a web server 122, and a real-time data manipulation system 124 that may be communicatively coupled with one or more databases 126 and one or more BW cubes 128.

The one or more databases 126 may be storage devices that store data related to users of the system 100, applications associated with the system 100, cloud services, machine learning models, parameters, and so forth. The one or more databases 126 may further store information related to third-party server system 130, third-party applications 132, third-party database(s) 134, client devices 110, client applications 114, users 106, and so forth. In one example, the one or more databases 126 is cloud-based storage.

The one or more BW cubes 128 are each an object on which queries can be defined or executed, as explained above.

The server system 102 may be a cloud computing environment, according to some example embodiments. The server system 102, and any servers associated with the server system 102, may be associated with a cloud-based application, in one example embodiment.

The real-time data manipulation system 124 may provide back-end support for third-party applications 132 and client applications 114, which may include cloud-based applications. The real-time data manipulation system 124 may provide for real-time data manipulation via a BW cube, as described in further detail below. The real-time data manipulation system 124 may comprise one or more servers or other computing devices or systems.

The system 100 further includes one or more third-party server system 130. The one or more third-party server system 130 may include one or more third-party application(s). The one or more third-party application(s) 132, executing on third-party server(s) 130, may interact with the server system 102 via API server 120 via a programmatic interface provided by the API server 120. For example, one or more of the third-party applications 132 may request and utilize information from the server system 102 via the API server 120 to support one or more features or functions on a website hosted by the third party or an application hosted by the third party.

The third-party website or application 132, for example, may provide access to functionality and data supported by third-party server system 130. In one example embodiment, the third-party website or application 132 may provide access to functionality that is supported by relevant functionality and data in the third-party server system 130. In one example, a third-party server system 130 is a system associated with an entity that accesses cloud services via server system 102.

The third-party database(s) 134 may be storage devices that store data related to users of the third-party server system 130, applications associated with the system 130, cloud services, machine learning models, parameters, and so forth. The one or more databases 126 may further store information related to third-party applications 132, client devices 110, client applications 114, users 106, and so forth. In one example, the one or more databases 134 is cloud-based storage.

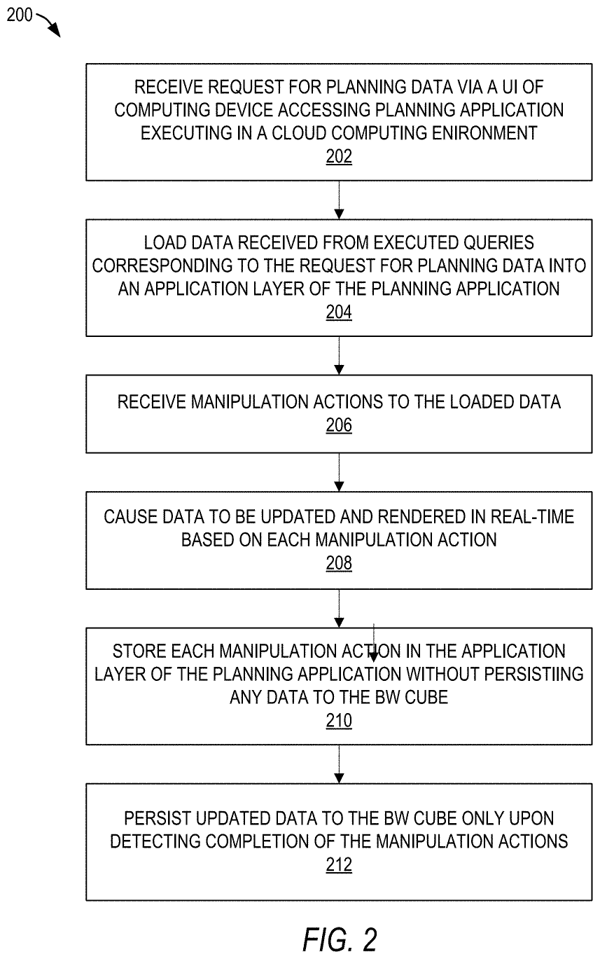

FIG. 2 is a flow chart illustrating aspects of a method 200 for real-time data manipulation via a BW cube, according to some example embodiments. For illustrative purposes, method 200 is described with respect to the block diagram of FIG. 1. It is to be understood that method 200 may be practiced with other system configurations in other embodiments.

In operation 202, a computing system (e.g., server system 102 or real-time data manipulation system 124), receives, by one or more processors of the computing system, a request for planning data. In one example, the computing system is part of a cloud computing environment and the request for planning data is received via a user interface of a computing device (e.g., client device 110) that is accessing a planning application executing in the cloud computing environment. For example, a user via a web client 112 or similar user interface may access the planning application, which automatically requests planning data to render in the user interface.

Upon receipt of the request for planning data, the computing system executes one or more queries corresponding to the request for planning data against a BW cube. The queries are executed based on the type of planning to be generated. In one example, the queries are executed on more than one table or data set in the BW cube. For example, if a user is planning a construction project, the data needed for planning the construction project, such as material types, material costs, labor types, labor costs, permit types, and so forth, are retrieved via the one or more queries. The data needed for planning the construction project is typically in more than one table or data set.

In one example, the BW cube consists of a set of relational tables that are joined logically to form an extended star system. In one example, the BW cube virtually collects data from one or more server systems, without storing the collected data permanently. In one example, the BW cube collects data from two or more server systems where at least one server system of the two or more server systems resides in a different physical location than at least one other server system.

In operation 204, the computing system loads data received from the executed queries into an application layer of the computing device executing in the cloud environment. For example, the real-time data manipulation system 124 may comprise one or more planning applications. Each application may comprise a user interface or presentation layer for rendering data in a user interface and receiving input from a user via the user interface, an application layer for processing and manipulating data, and a data layer for accessing the BW cube. In one example, the computing system loads data received from the executed queries into one or more buffers in the application layer.

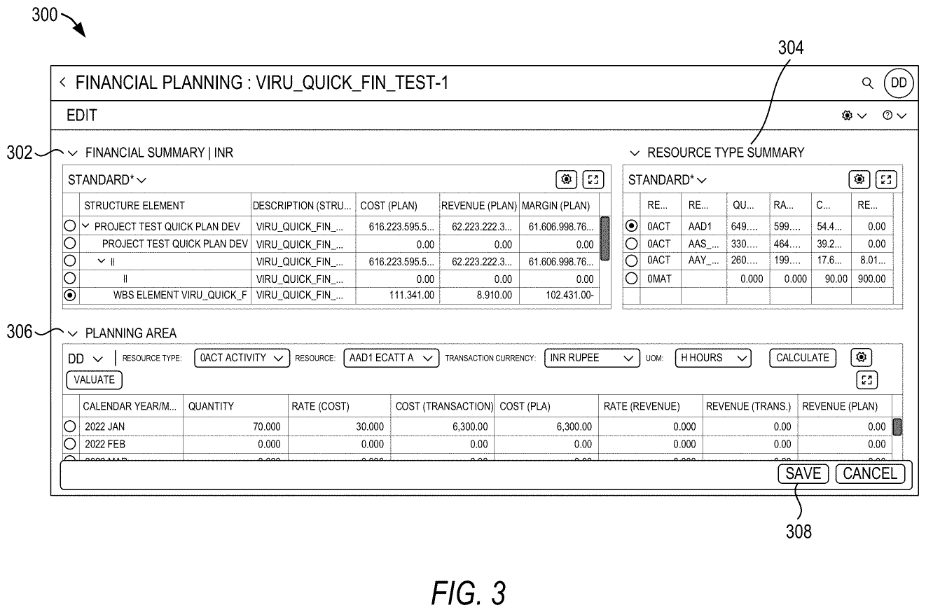

The computing system causes the loaded data to be rendered (e.g., via the user interface or presentation layer of the planning application) in the user interface of the computing device accessing the planning application executing in the cloud environment. FIG. 3 illustrates an example user interface 300 where the loaded data is rendered. The example user interface 300 comprises a financial summary 302 that give a high level visual of the project status. The example user interface 300 also comprises a resource type summary 304 that shows at each level how the planning is done including which resources have been used, how much of each resource has been used, and so forth. The example user interface 300 further comprises a planning area 306 where a user can perform actions on the data to effect and be reflected by the financial summary 302 and the resource type summary 304.

Returning to FIG. 2, in operation 206, the computing system receives manipulation actions to the loaded data. For example, the computing system receives, via the user interface of the computing device accessing the planning application executing in the cloud environment, a plurality of manipulation actions to the loaded data received from the executed queries. Using the example in FIG. 3, a user can perform manipulation actions in the planning area 306, for example, such as editing a quantity, rate, or revenue for a particular calendar year and month. As the user is updating the data in the planning area 306, the financial summary 302 and resource type summary 304 are automatically updated in real-time to reflect the changes made (e.g., the manipulation actions) by the user. It is to be understood that this is just one example of what kind of data can be manipulated and that example embodiments also apply to other types of planning data manipulations.

In operation 208, the computing system causes data to be updated and rendered in real-time, based on each manipulation action of the plurality of manipulation actions, in the user interface on the computing device accessing the planning application executing in the cloud computing environment. For example, for each change or input made to the planning data by the user via the user interface on the computing device, the computing system processor calculates updated visual information based on those updates and renders, in real-time, the updated data in the user interface of the computing device.

In operation 210, the computing system stores each manipulation action of the plurality of manipulation actions in the application layer of the planning application executing in the cloud computing environment without persisting any data to the BW cube. As explained above, it is very costly to perform a remote function call to the BW cube each time any change is made by the user. For example, it can take up to a minute to effect the change in the BW cube and is very resource intensive. Thus, instead of a remote function call to the BW cube, the computing system stores each manipulation (and updated data) in the application layer of the planning application executing in the cloud computing environment without persisting any data to the BW cube. In one example, each manipulation action with intermediate result is stored in one or more buffers of the application layer. This allows for manipulation and simulation of the result before persisting to the BW cube.

For example, the user may make a first manipulation action to change data associated with a first data set. The intermediate data associated with the first manipulation action is stored in a buffer in the application layer and the computing system reloads the analytical reports with the intermediate data. The intermediate data is not yet persisted. The user then performs a second manipulation action to change data associated with a second data set. The intermediate data associated with the second manipulation action is stored in the buffer in the application layer and the computing device reloads the analytical reports with this intermediate data. This continues for each manipulation action performed by the user via the user interface until the user is finished manipulating the data and triggers a save action. In this way the page or analytical reports are refreshed in real-time with buffered data so the changes are always reflected in the user interface, without persisting the data to the BW cube.

Once the user has completed all the desired manipulations to the planning data, the user can save the plan. For example, the user can select a save option in the user interface of the computing device, such as the save option 308 shown in FIG. 3. The computing system detects completion of the manipulation actions in the planning application via the user interface of the computing device accessing the planning application executing in the cloud environment, and, in operation 212 persists updated data to the BW cube. The updated data is persisted to the BW cube only after detecting completion of the manipulation actions. Thus, based on detecting the completion of the manipulation actions in the planning application, the computing system persists updated data based on the plurality of manipulation actions to the BW cube. The updated data is not persisted to the BW cube until the completion of the manipulations actions is detected. In this way only one function call is made at the end to the BW cube which results in a more efficient system that is faster (less than a second versus the conventional system taking up to a minute for each change to the data) and is less resource intensive.

In view of the above disclosure, various examples are set forth below. It should be noted that one or more features of an example, taken in isolation or combination, should be considered within the disclosure of this application.

Example 1. A computer-implemented method comprising:

receiving, by one or more processors of a computing system in a cloud computing environment, a request for planning data via a user interface of a computing device accessing a planning application executing in the cloud computing environment;

executing, by the one or more processors, queries corresponding to the request for planning data against an SAP Business Warehouse Integrated Planning Cube (BW cube), the BW cube consisting of a set of relational tables that are joined logically to form an extended star schema;

loading data received from the executed queries into an application layer of the planning application executing in the cloud computing environment;

causing the loaded data to be rendered in the user interface of the computing device accessing the planning application executing in the cloud computing environment;

receiving, via the user interface of the computing device accessing the planning application executing in the cloud computing environment, a plurality of manipulation actions to the loaded data received from the executed queries;

causing data to be updated and rendered in real-time, based on each manipulation action of the plurality of manipulation actions, in the user interface on the computing device accessing the planning application executing in the cloud computing environment;

storing each manipulation action of the plurality of manipulation actions in the application layer of the planning application executing in the cloud computing environment without persisting any data to the BW cube;

detecting completion of manipulation actions in the planning application via the user interface of the computing device accessing the planning application executing in the cloud computing environment; and

based on detecting the completion of manipulation actions in the planning application, persisting updated data based on the plurality of manipulation actions to the BW cube, wherein the updated data is not persisted to the BW cube until the completion of manipulation actions is detected.

Example 2. A computer-implemented method according to any of the previous examples, wherein the queries are executed based on the type of planning to be generated.
Example 3. A computer-implemented method according to any of the previous examples, wherein the BW cube virtually collects data from one or more server systems without storing it permanently.
Example 4. A computer-implemented method according to any of the previous examples, wherein the BW cube collects data from two or more server systems residing in different physical locations.
Example 5. A computer-implemented method according to any of the previous examples, wherein loading data received from the executed queries into an application layer of the planning application executing in the cloud computing environment comprises loading the data received from the executed queries into one or more buffers in the application layer.
Example 6. A computer-implemented method according to any of the previous examples, wherein storing each manipulation action of the plurality of manipulation actions in the application layer of the planning application executing in the cloud computing environment comprises storing each manipulation action in the one or more buffers of the application layer.
Example 7. A computer-implemented method according to any of the previous examples, wherein detecting completion of manipulation actions via the user interface of the computing device accessing the planning application executing in the cloud computing environment comprises detecting selection of a save option in the user interface.
Example 8. A system in a cloud computing environment comprising:

a memory that stores instructions; and

one or more processors configured by the instructions to perform operations comprising:
receiving a request for planning data via a user interface of a computing device accessing a planning application executing in the cloud computing environment;
executing queries corresponding to the request for planning data against an SAP Business Warehouse Integrated Planning Cube (BW cube), the BW cube consisting of a set of relational tables that are joined logically to form an extended star schema;
loading data received from the executed queries into an application layer of the planning application executing in the cloud computing environment;
causing the loaded data to be rendered in the user interface of the computing device accessing the planning application executing in the cloud computing environment;
receiving, via the user interface of the computing device accessing the planning application executing in the cloud environment, a plurality of manipulation actions to the loaded data received from the executed queries;
causing data to be updated and rendered in real-time, based on each manipulation action of the plurality of manipulation actions, in the user interface on the computing device accessing the planning application executing in the cloud computing environment;
storing each manipulation action of the plurality of manipulation actions in the application layer of the planning application executing in the cloud computing environment without persisting any data to the BW cube;
detecting completion of manipulation actions in the planning application via the user interface of the computing device accessing the planning application executing in the cloud computing environment; and
based on detecting the completion of manipulation actions in the planning application, persisting updated data based on the plurality of manipulation actions to the BW cube, wherein the updated data is not persisted to the BW cube until the completion of manipulation actions is detected.
   Example 9. A system according to any of the previous examples, wherein the queries are executed based on the type of planning to be generated.
   Example 10. A system according to any of the previous examples, wherein the BW cube virtually collects data from one or more server systems without storing it permanently.
   Example 11. A system according to any of the previous examples, wherein the BW cube collects data from two or more server systems residing in different physical locations.
   Example 12. A system according to any of the previous examples, wherein loading data received from the executed queries into an application layer of the planning application executing in the cloud computing environment comprises loading the data received from the executed queries into one or more buffers in the application layer.
   Example 13. A system according to any of the previous examples, wherein storing each manipulation action of the plurality of manipulation actions in the application layer of the planning application executing in the cloud computing environment comprises storing each manipulation action in the one or more buffers of the application layer.
   Example 14. A system according to any of the previous examples, wherein detecting completion of manipulation actions via the user interface of the computing device accessing the planning application executing in the cloud computing environment comprises detecting selection of a save option in the user interface.
   Example 15. A non-transitory computer-readable medium comprising instructions stored thereon that are executable by at least one processor to cause a computing device to perform operations comprising:

receiving a request for planning data via a user interface of a computing device accessing a planning application executing in a cloud computing environment;

executing queries corresponding to the request for planning data against an SAP Business Warehouse Integrated Planning Cube (BW cube), the BW cube consisting of a set of relational tables that are joined logically to form an extended star schema;

loading data received from the executed queries into an application layer of the planning application executing in the cloud computing environment;

causing the loaded data to be rendered in the user interface of the computing device accessing the planning application executing in the cloud computing environment;

receiving, via the user interface of the computing device accessing the planning application executing in the cloud computing environment, a plurality of manipulation actions to the loaded data received from the executed queries;

causing data to be updated and rendered in real-time, based on each manipulation action of the plurality of manipulation actions, in the user interface on the computing device accessing the planning application executing in the cloud computing environment;

storing each manipulation action of the plurality of manipulation actions in the application layer of the planning application executing in the cloud computing environment without persisting any data to the BW cube;

detecting completion of manipulation actions in the planning application via the user interface of the computing device accessing the planning application executing in the cloud computing environment; and based on detecting the completion of manipulation actions in the planning application, persisting updated data based on the plurality of manipulation actions to the BW cube, wherein the updated data is not persisted to the BW cube until the completion of manipulation actions is detected.

Example 16. A non-transitory computer-readable medium according to any of the previous examples, wherein the queries are executed based on the type of planning to be generated.
Example 17. A non-transitory computer-readable medium according to any of the previous examples, wherein the BW cube virtually collects data from one or more server systems without storing it permanently.
Example 18. A non-transitory computer-readable medium according to any of the previous examples, wherein the BW cube collects data from two or more server systems residing in different physical locations.
Example 19. A non-transitory computer-readable medium according to any of the previous examples, wherein loading data received from the executed queries into an application layer of the planning application executing in the cloud computing environment comprises loading the data received from the executed queries into one or more buffers in the application layer and wherein storing each manipulation action of the plurality of manipulation actions in the application layer of the planning application executing in the cloud computing environment comprises storing each manipulation action in the one or more buffers of the application layer.
Example 20. A non-transitory computer-readable medium according to any of the previous examples, wherein detecting completion of manipulation actions via the user interface of the computing device accessing the planning application executing in the cloud computing environment comprises detecting selection of a save option in the user interface.

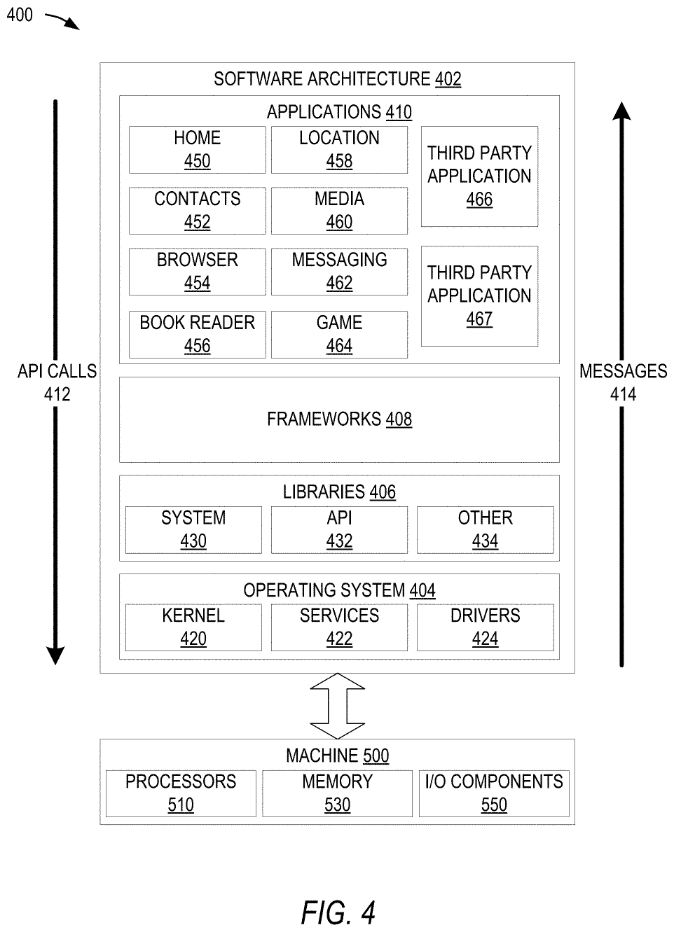

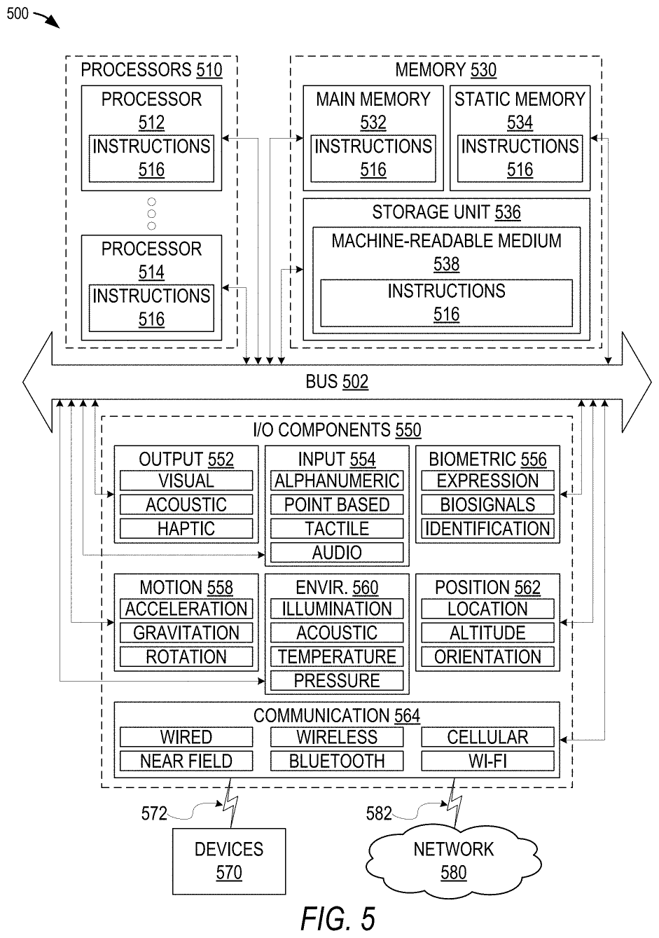

FIG. 4 is a block diagram 400 illustrating software architecture 402, which can be installed on any one or more of the devices described above. For example, in various embodiments, client devices 110 and servers and systems 130, 102, 120, 122, and 124 may be implemented using some or all of the elements of software architecture 402. FIG. 4 is merely a non-limiting example of a software architecture, and it will be appreciated that many other architectures can be implemented to facilitate the functionality described herein. In various embodiments, the software architecture 402 is implemented by hardware such as machine 500 of FIG. 5 that includes processors 510, memory 530, and I/O components 550. In this example, the software architecture 402 can be conceptualized as a stack of layers where each layer may provide a particular functionality. For example, the software architecture 402 includes layers such as an operating system 404, libraries 406, frameworks 408, and applications 410. Operationally, the applications 410 invoke application programming interface (API) calls 412 through the software stack and receive messages 414 in response to the API calls 412, consistent with some embodiments.

In various implementations, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionality. The services 422 can provide other common services for the other software layers. The drivers 424 are responsible for controlling or interfacing with the underlying hardware, according to some embodiments. For instance, the drivers 424 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410, according to some embodiments. For example, the frameworks 408 provide various graphic user interface (GUI) functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications such as third-party applications 466 and 467. According to some embodiments, the applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 is a block diagram illustrating components of a machine 500, according to some embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application 410, an applet, an app, or other executable code) for causing the machine 500 to perform any one or more of the methodologies discussed herein can be executed. In alternative embodiments, the machine 500 operates as a standalone device or can be coupled (e.g., networked) to other machines. In a networked deployment, the machine 500 may operate in the capacity of a server machine or system 130, 102, 120, 122, 124, etc., or a client device 110 in a server-client network environment, or as a peer machine in a peer-to-peer (or distributed) network environment. The machine 500 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

In various embodiments, the machine 500 comprises processors 510, memory 530, and I/O components 550, which can be configured to communicate with each other via a bus 502. In an example embodiment, the processors 510 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 512 and a processor 514 that may execute the instructions 516. The term “processor” is intended to include multi-core processors 510 that may comprise two or more independent processors 512, 514 (also referred to as “cores”) that can execute instructions 516 contemporaneously. Although FIG. 5 shows multiple processors 510, the machine 500 may include a single processor 510 with a single core, a single processor 510 with multiple cores (e.g., a multi-core processor 510), multiple processors 512, 514 with a single core, multiple processors 512, 514 with multiples cores, or any combination thereof.

The memory 530 comprises a main memory 532, a static memory 534, and a storage unit 536 accessible to the processors 510 via the bus 502, according to some embodiments. The storage unit 536 can include a machine-readable medium 538 on which are stored the instructions 516 embodying any one or more of the methodologies or functions described herein. The instructions 516 can also reside, completely or at least partially, within the main memory 532, within the static memory 534, within at least one of the processors 510 (e.g., within the processor's cache memory), or any suitable combination thereof, during execution thereof by the machine 500. Accordingly, in various embodiments, the main memory 532, the static memory 534, and the processors 510 are considered machine-readable media 538.

As used herein, the term “memory” refers to a machine-readable medium 538 able to store data temporarily or permanently and may be taken to include, but not be limited to, random-access memory (RAM), read-only memory (ROM), buffer memory, flash memory, and cache memory. While the machine-readable medium 538 is shown, in an example embodiment, to be a single medium, the term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions 516, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 550 include a wide variety of components to receive input, provide output, produce output, transmit information, exchange information, capture measurements, and so on. In general, it will be appreciated that the I/O components 550 can include many other components that are not shown in FIG. 5. The I/O components 550 are grouped according to functionality merely for simplifying the following discussion, and the grouping is in no way limiting. In various example embodiments, the I/O components 550 include output components 552 and input components 554. The output components 552 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 554 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 550 include biometric components 556, motion components 558, environmental components 560, or position components 562, among a wide array of other components. For example, the biometric components 556 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 include acceleration sensor components (e.g., accelerometer), gravitation sensor components, rotation sensor components (e.g., gyroscope), and so forth. The environmental components 560 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 562 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 550 may include communication components 564 operable to couple the machine 500 to a network 580 or devices 570 via a coupling 582 and a coupling 572, respectively. For example, the communication components 564 include a network interface component or another suitable device to interface with the network 580. In further examples, communication components 564 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 570 may be another machine 500 or any of a wide variety of peripheral devices (e.g., a peripheral device coupled via a Universal Serial Bus (USB)).

Moreover, in some embodiments, the communication components 564 detect identifiers or include components operable to detect identifiers. For example, the communication components 564 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 564, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 580 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 516 are transmitted or received over the network 580 using a transmission medium via a network interface device (e.g., a network interface component included in the communication components 564) and utilizing any one of a number of well-known transfer protocols (e.g., Hypertext Transfer Protocol (HTTP)). Similarly, in other example embodiments, the instructions 516 are transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

Furthermore, the machine-readable medium 538 is non-transitory (in other words, not having any transitory signals) in that it does not embody a propagating signal. However, labeling the machine-readable medium 538 “non-transitory” should not be construed to mean that the medium is incapable of movement; the medium 538 should be considered as being transportable from one physical location to another. Additionally, since the machine-readable medium 538 is tangible, the medium 538 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
receiving, by one or more processors of a computing system in a cloud computing environment, a request for planning data via a user interface of a computing device accessing a planning application executing in the cloud computing environment;
executing, by the one or more processors, queries corresponding to the request for planning data against an SAP Business Warehouse Integrated Planning Cube (BW cube), the BW cube consisting of a set of relational tables that are joined logically to form an extended star schema;
loading data received from the executed queries into an application layer of the planning application executing in the cloud computing environment;
causing the loaded data to be rendered in the user interface of the computing device accessing the planning application executing in the cloud computing environment;
receiving, via the user interface of the computing device accessing the planning application executing in the cloud computing environment, a plurality of manipulation actions to the loaded data received from the executed queries;
causing data to be updated and rendered in real-time, based on each manipulation action of the plurality of manipulation actions, in the user interface on the computing device accessing the planning application executing in the cloud computing environment;
storing each manipulation action of the plurality of manipulation actions in the application layer of the planning application executing in the cloud computing environment without persisting any data to the BW cube;
detecting completion of manipulation actions in the planning application via the user interface of the computing device accessing the planning application executing in the cloud computing environment; and
based on detecting the completion of manipulation actions in the planning application, persisting updated data based on the plurality of manipulation actions to the BW cube, wherein the updated data is not persisted to the BW cube until the completion of manipulation actions is detected.

2. The computer-implemented method of claim 1, wherein the queries are executed based on the type of planning to be generated.

3. The computer-implemented method of claim 1, wherein the BW cube virtually collects data from one or more server systems without storing it permanently.

4. The computer-implemented method of claim 3, wherein the BW cube collects data from two or more server systems residing in different physical locations.

5. The computer-implemented method of claim 1, wherein loading data received from the executed queries into an application layer of the planning application executing in the cloud computing environment comprises loading the data received from the executed queries into one or more buffers in the application layer.

6. The computer-implemented method of claim 5, wherein storing each manipulation action of the plurality of manipulation actions in the application layer of the planning application executing in the cloud computing environment comprises storing each manipulation action in the one or more buffers of the application layer.

7. The computer-implemented method of claim 1, wherein detecting completion of manipulation actions via the user interface of the computing device accessing the planning application executing in the cloud computing environment comprises detecting selection of a save option in the user interface.

8. A system in a cloud computing environment comprising:
a memory that stores instructions; and
one or more processors configured by the instructions to perform operations comprising:
receiving a request for planning data via a user interface of a computing device accessing a planning application executing in the cloud computing environment;
executing queries corresponding to the request for planning data against an SAP Business Warehouse Integrated Planning Cube (BW cube), the BW cube consisting of a set of relational tables that are joined logically to form an extended star schema;
loading data received from the executed queries into an application layer of the planning application executing in the cloud computing environment;
causing the loaded data to be rendered in the user interface of the computing device accessing the planning application executing in the cloud computing environment;
receiving, via the user interface of the computing device accessing the planning application executing in the cloud environment, a plurality of manipulation actions to the loaded data received from the executed queries;
causing data to be updated and rendered in real-time, based on each manipulation action of the plurality of manipulation actions, in the user interface on the computing device accessing the planning application executing in the cloud computing environment;
storing each manipulation action of the plurality of manipulation actions in the application layer of the planning application executing in the cloud computing environment without persisting any data to the BW cube;
detecting completion of manipulation actions in the planning application via the user interface of the computing device accessing the planning application executing in the cloud computing environment; and
based on detecting the completion of manipulation actions in the planning application, persisting updated data based on the plurality of manipulation actions to the BW cube, wherein the updated data is not persisted to the BW cube until the completion of manipulation actions is detected.

9. The system of claim 8, wherein the queries are executed based on the type of planning to be generated.

10. The system of claim 8, wherein the BW cube virtually collects data from one or more server systems without storing it permanently.

11. The system of claim 10, wherein the BW cube collects data from two or more server systems residing in different physical locations.

12. The system of claim 8, wherein loading data received from the executed queries into an application layer of the planning application executing in the cloud computing environment comprises loading the data received from the executed queries into one or more buffers in the application layer.

13. The system of claim 12, wherein storing each manipulation action of the plurality of manipulation actions in the application layer of the planning application executing in the cloud computing environment comprises storing each manipulation action in the one or more buffers of the application layer.

14. The system of claim 8, wherein detecting completion of manipulation actions via the user interface of the computing device accessing the planning application executing in the cloud computing environment comprises detecting selection of a save option in the user interface.

15. A non-transitory computer-readable medium comprising instructions stored thereon that are executable by at least one processor to cause a computing device to perform operations comprising:
receiving a request for planning data via a user interface of a computing device accessing a planning application executing in a cloud computing environment;
executing queries corresponding to the request for planning data against an SAP Business Warehouse Integrated Planning Cube (BW cube), the BW cube consisting of a set of relational tables that are joined logically to form an extended star schema;
loading data received from the executed queries into an application layer of the planning application executing in the cloud computing environment;
causing the loaded data to be rendered in the user interface of the computing device accessing the planning application executing in the cloud computing environment;
receiving, via the user interface of the computing device accessing the planning application executing in the cloud computing environment, a plurality of manipulation actions to the loaded data received from the executed queries;
causing data to be updated and rendered in real-time, based on each manipulation action of the plurality of manipulation actions, in the user interface on the computing device accessing the planning application executing in the cloud computing environment;
storing each manipulation action of the plurality of manipulation actions in the application layer of the planning application executing in the cloud computing environment without persisting any data to the BW cube;
detecting completion of manipulation actions in the planning application via the user interface of the computing device accessing the planning application executing in the cloud computing environment; and
based on detecting the completion of manipulation actions in the planning application, persisting updated data based on the plurality of manipulation actions to the BW cube, wherein the updated data is not persisted to the BW cube until the completion of manipulation actions is detected.

16. The non-transitory computer-readable medium of claim 15, wherein the queries are executed based on the type of planning to be generated.

17. The non-transitory computer-readable medium of claim 15, wherein the BW cube virtually collects data from one or more server systems without storing it permanently.

18. The non-transitory computer-readable medium of claim 15, wherein the BW cube collects data from two or more server systems residing in different physical locations.

19. The non-transitory computer-readable medium of claim 15, wherein loading data received from the executed queries into an application layer of the planning application executing in the cloud computing environment comprises loading the data received from the executed queries into one or more buffers in the application layer and wherein storing each manipulation action of the plurality of manipulation actions in the application layer of the planning application executing in the cloud computing environment comprises storing each manipulation action in the one or more buffers of the application layer.

20. The non-transitory computer-readable medium of claim 15, wherein detecting completion of manipulation actions via the user interface of the computing device accessing the planning application executing in the cloud computing environment comprises detecting selection of a save option in the user interface.
